(19) United States
(12) Patent Application Publication
(10) Pub. No.: US 2008/0202387 A1
(43) Pub. Date: Aug. 28, 2008

(54) Process For Producing Silica and Sodium Sulfite With Sodium Sulfate

(76) Inventor: Yuanjian Lu, Fujian (CN)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/916,863

(22) PCT Filed: Jun. 6, 2005
(86) PCT No.: PCT/CN06/01226

§ 371 Date: Mar. 5, 2008

(30) Foreign Application Priority Data
Jun. 8, 2005 (CN) 200510200314.7

(51) Int. Cl. C04B 14/04

(52) U.S. Cl. 106/482

(57) ABSTRACT

A method is provided to produce silica and sodium sulfite with sodium sulfate, wherein a mixture of quartz sand, sodium sulfate and carbon is reacted to produce solid sodium silicate and sulfur dioxide; said solid sodium silicate is dissolved in water and then filtered to obtain a sodium silicate solution; said sodium silicate solution is brought into contact with the sulfur dioxide to produce precipitated silica and sodium sulfite solution; the resultant mixture is filtered; the filter cake is acidified and then goes through filtration, washing and drying to obtain silica; and the filtrate is concentrated and dried to get sodium sulfite. The process of the present invention has great value due to its simple steps, low production cost and reduction of environmental problems.

The present invention provides a process for producing silica and sodium sulfite with sodium sulfate.

Precipitated silica, also called light silicon dioxide or white carbon, is used as filler for rubber; as well as lubricant, insulation material, filling material of plastics, paper, paint and textile and white pigment. Nowadays, the most common method to produce silica is the precipitation method. Water glass (sodium silicate) employed in these processes is prepared by reaction of quartz sand with soda (anhydrate sodium carbonate). These processes, however, require a large quantity of soda, resulting in high production cost.

The purpose of the present invention is to provide a new process for producing precipitated silica while reducing the cost of production and environmental problems.

The present invention involves the following reaction schemes:

2Na₂SO₄+2nSiO₂+C→2Na₂O.nSiO₂+2SO₂+CO₂

SO₂+Na₂O.nSiO₂→2SiO₂+Na₂SO₃

An embodiment of the present invention, therefore, is a process for producing silica and sodium sulfite with sodium sulfate. Its character lies in using sodium sulfate instead of soda to produce sodium silicate. In addition SO₂ instead of sulfuric acid is used for the precipitation of silica.

In particular, a mixture of quartz sand, sodium sulfate and carbon in a weight ratio of 118.3˜147.9:100:4˜12 is heated in a furnace at a temperature of 1200-1500° C. to produce solid sodium silicate and sulfur dioxide. Said solid sodium silicate is dissolved with water in a weight ratio of 100:180˜488 and then filtered. The resulting sodium silicate solution is brought into contact with sulfur dioxide, preferably the sulfur dioxide obtained during the production of the sodium silicate, in a mole ratio of 1:1. The reaction is carried out at 70-100° C. over a period of 1-4 hours and is followed by a filtration step. The filter cake obtained is acidified to pH 3.5-6.0, and then goes through filtration, washing and drying to obtain silica. The filtrate is concentrated and dried to obtain sodium sulfite.

In a preferred embodiment of the invention, a thermal insulation horseshoe-flame furnace is used for the production of sodium silicate with sodium sulfate. The process of the present invention can be used as a batch process or as a continuous process. A continuous production of water glass or continuous overall process is preferred.

Compared with the existing techniques, the present invention has the following advantages:

(I) No sodium hydroxide or soda is needed, while sodium sulfate is much cheaper than soda;

(II) No sulfuric acid or hydrochloric acid is needed for the precipitation process, and only minor amount of acid is needed to acidify the filter cake;

(III) The by product sodium sulfite is a valuable material for different applications in chemical industry and can therefore be commercialized;

(IV) No waste.

The following examples are intended to demonstrate and explain the present invention without restriction or limitation of the scope of the invention.

### EXAMPLE

Quartz sand, sodium sulfate and carbon (crushed) were mixed in a weight ratio of 100:81.4:6.5%. The obtained mixture was charged continuously into a thermal insulation horseshoe-flame furnace and heated to 1420˜1450° C. The obtained solid sodium silicate was dissolved in water and filtered to obtain a 3.5 M and 29 Be'sodium silicate (water glass) solution.

A 1 l reactor was charged with 0.4 l of water and 0.013 l of said sodium silicate solution and heated to 86° C. 0.187 l of said sodium silicate solution and 5% sulfur dioxide were metered simultaneously into the reactor over a period of 120 min. The reaction product was filtered.

The pH of the filter cake was adjusted to pH 4.6 with acid followed by filtration, washing and a drying. 56.24 g of silica with BET of 235 m²/g was obtained.

The filtrate containing sodium sulfite solution was concentrated and dried and 30.17 g of solid sodium sulfite were obtained.

The process of the present invention has great value due to its simple steps, low production cost and reduction of environmental problems.

What is claimed is:

1. A process for producing silica and sodium sulfite by using sodium sulfate, characterized in that
quartz sand, sodium sulfate and carbon are mixed in a weight ratio of 118.3˜147.9:100:4˜12 and then transferred into a furnace and heated at a temperature of 1200-1500° C. to produce solid sodium silicate and sulfur dioxide;
said solid sodium silicate is dissolved into water in a weight ratio of 100:180˜488 and filtered to produce a sodium silicate solution;
sulfur dioxide, preferably the sulfur dioxide produced during the production of the solid sodium silicate, is introduced into said sodium silicate solution in a mole ratio of 1:1 and the reaction is carried out at 70-100° C. for 1˜4 hours;
the resulting mixture is filtered;
silica and sodium sulfite are obtained after following steps:
(1) The filter cake is acidified to pH 3.5-6.0, followed by filtration, washing and drying to obtain silica;
(2) The filtrate is concentrated and dried to obtain sodium sulfite.

2. The process for producing silica and sodium sulfite according to claim 1, characterized in that said furnace is a thermal insulation horseshoe-flame furnace.
